(19) United States
(12) Patent Application Publication
(10) Pub. No.: US 2004/0109071 A1
(43) Pub. Date: Jun. 10, 2004

(54) Image capturing apparatus

(75) Inventors: Toshihito Kido, Matsubara-shi (JP); Masahito Niikawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/376,464

(22) Filed: Feb. 28, 2003

(30) Foreign Application Priority Data
Dec. 5, 2002 (JP) 2002-353494

(51) Int. Cl. H04N 5/76

(52) U.S. Cl. 348/231.2

(57) ABSTRACT

The present invention provides an image capturing apparatus capable of easily capturing a plurality of images of different fields of view. A digital camera has a single CCD image capturing device, alternately reads two images PA and PB (for example, an image PA corresponding to the whole area of the CCD image capturing device and an image PB corresponding to a partial area of the CCD image capturing device) from different areas on the CCD image capturing device, records the images PA and PB, and generates moving image data. After the reading mode is changed, the images PA and PB are alternately read. It is also possible to extract two images from images which are read at once from the CCD image capturing device without changing the reading mode.

This application is based on application No. 2002-353494 filed in Japan, the contents of which are hereby incorporated by reference.

### BACKGROUND OF THE INVENTION

1. Field of the Invention

The present invention relates to an image capturing apparatus capable of capturing a plurality of images.

2. Description of the Background Art

There is an image capturing apparatus for photographing a subject at the same time point and capturing a plurality of images of different fields of view. For example, an image capturing apparatus disclosed in Japanese Patent Application Laid-open No. 2002-135706 (hereinafter, also referred to as Patent Literature 1) is known.

Patent Literature 1 describes a multi-angle image capturing apparatus for photographing a subject from different angles by using a plurality of cameras and recording images.

The technique of Patent Literature 1 is achieved on condition that a plurality of cameras is used. An apparatus of the technique is therefore large and has a problem such that it is difficult to easily capture a plurality of images of different fields of view.

### SUMMARY OF THE INVENTION

An object of the present invention is to provide an image capturing apparatus capable of easily capturing a plurality of images of different fields of view.

In order to achieve the object, according to a first aspect of the present invention, an image capturing apparatus includes: a single image capturing unit having an image capturing optical system and at least one image sensor for generating image data constructed by a plurality of pixels by using photoelectric conversion on a subject image from the image capturing optical system; a first reader for reading image data of a first area in the at least one image sensor; a second reader for reading image data of a second area in the at least one image sensor; a reading controller for alternately performing reading of image data by the first reader and reading of image data by the second reader; a first recorder for recording the image data read by the first reader; and a second recorder for recording the image data read by the second reader.

According to the image capturing apparatus, image data corresponding to the first area and image data corresponding to the second area is alternately read from at least one image sensor in the single image capturing unit and recorded. Thus, it is unnecessary to prepare a plurality of cameras, and a plurality of images of different fields of view can be captured easily.

According to a second aspect of the present invention, the image capturing apparatus includes: a single image capturing unit having an image capturing optical system and at least one image sensor for generating image data constructed by a plurality of pixels by using photoelectric conversion on a subject image from the image capturing optical system; a reader for reading image data of first and second areas in the at least one image sensor; a first recorder for recording the image data of the first area read by the reader; a second recorder for recording the image data of the second area read by the reader; and a recording controller for alternately performing the recording of image data by the first recorder and the recording of image data by the second recorder to generate moving image data.

According to the image capturing apparatus, image data corresponding to the area including the first and second areas is read once from the image sensor, image data corresponding to the first area and image data corresponding to the second area is alternately recorded, thereby generating two pieces of moving image data. Consequently, it is unnecessary to prepare a plurality of cameras, and a plurality of images of different fields of view can be captured easily.

According to a third aspect of the present invention, an image capturing apparatus includes: at least one image sensor for generating image data; a first reader for reading image data of a first area in the at least one image sensor; a second reader for reading image data of a second area in the at least one image sensor; a first file generator for generating a first moving image file from the image data read by the first reader; a second file generator for generating a second moving image file from the image data read by the second reader; and a file recorder for recording the first and second moving image files generated by the first and second file generators into a recording medium.

According to the image capturing apparatus, image data corresponding to a plurality of areas in the at least one image sensor is recorded as a plurality of moving image files. Consequently, it is unnecessary to prepare a plurality of cameras, and a plurality of images of different fields of view can be easily captured.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an external configuration of a digital camera;

FIG. 2 is a top view showing an external configuration of the digital camera;

FIG. 3 is a rear view showing an external configuration of the digital camera;

FIG. 4 is a block diagram showing an internal function of the digital camera;

FIG. 5 is a conceptual diagram showing the relationship between a live view image and a recording image;

FIG. 6 is a flowchart showing operations of a digital camera according to a first embodiment;

FIGS. 7A to 7D show an image read in a draft mode;

FIGS. 8A to 8D show an image read in a partial reading mode;

FIG. 9 is a timing chart showing operations in the first embodiment;

FIG. 10 shows a frame structure of each moving image;

FIGS. 11A to 11C describe a rule of assigning a file name;

FIG. 12 shows a metering block;

FIG. 13 shows a metering block of a partial image PB;

FIG. 14 shows designation of a read pixel in a CMOS sensor;

FIG. 15 shows designation of a read pixel in the CMOS sensor;

FIG. 16 shows the relationship between an image showing a whole image capturing range and a recording image as a part of the image;

FIG. 17 shows a reading position in a draft mode;

FIG. 18 shows a reading position in a partial reading mode;

FIG. 19 shows another reading position in the partial reading mode;

FIG. 20 shows operations in a third embodiment;

FIG. 21 shows an example of a program line for exposure control;

FIG. 22 is a flowchart showing operations in a fourth embodiment;

FIG. 23 shows an example of an image to be captured;

FIG. 24 describes the principle of calculating a center position of a moving subject;

FIG. 25 shows one of moving images;

FIG. 26 shows another moving image;

FIG. 27 shows a live view image;

FIG. 28 is a flowchart showing operations in a fifth embodiment; and

FIG. 29 shows a process of generating two recording images in the fifth embodiment.

### DESCRIPTION OF THE PREFERRED EMBODIMENTS

Hereinafter, embodiments of the present invention will be described with reference to the drawings.

### A. First Embodiment

### A1. Configuration

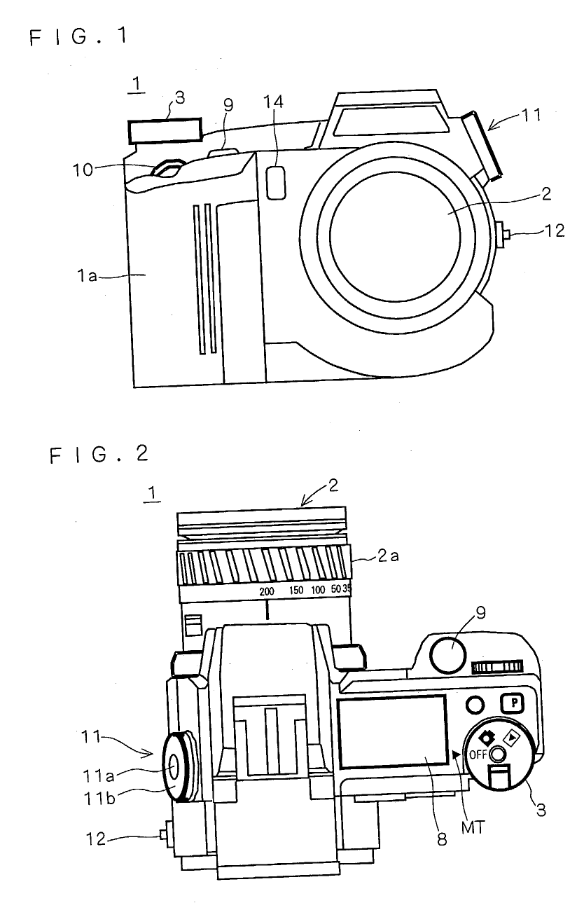

FIGS. 1, 2 and 3 are a front view, a top view and a rear view, respectively, each showing an external configuration of a digital camera 1 according to a first embodiment of the present invention. These figures are not always according to triangulation but a principal objective of the figures is to illustrate the appearance of the digital camera 1.

On the front face side of the digital camera 1, a taking lens 2 is provided. The taking lens 2 has a zooming function. By turning a zoom ring 2a by a manual operation, the magnification can be changed.

In the upper part of a grip 1a of the digital camera 1, a shutter start button (release button) 9 is provided. The shutter start button 9 is a two-stage switch capable of detecting a touched state by the user (hereinafter, also referred to as state S1) and a depressed state (hereinafter, also referred to as state S2) so as to be distinguished from each other. When an auto-focus mode is set, an auto-focus control starts in the touched state S1 and an image capturing operation for obtaining an image for recording starts in the depressed state S2.

On the top face of the digital camera 1, a dial 3 for mode switching which switches and sets an “image capturing mode” and a “reproduction mode” is provided. The image capturing mode is a mode of photographing a subject and generating image data. The reproduction mode is a mode of reproducing image data recorded in a memory card 90 and displaying the image data on a liquid crystal display (hereinafter, referred to as LCD) 5 provided on the rear face side of the digital camera 1.

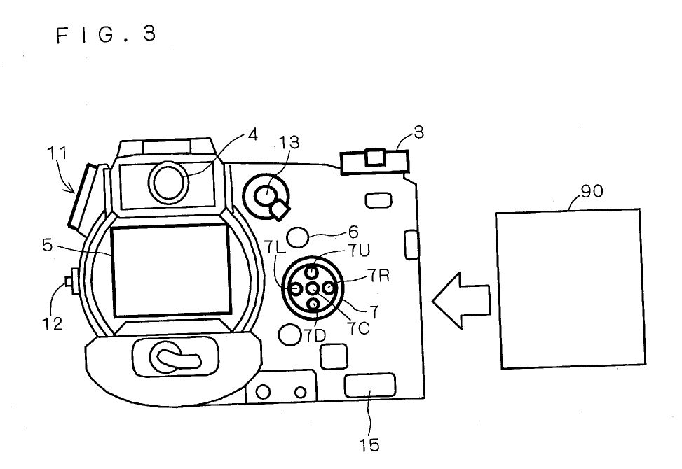

Concretely, by turning the dial 3 so that a part indicated as “image capturing mark” indicative of the image capturing mode comes to a predetermined position (a triangle mark MT in FIG. 2), the image capturing mode can be set. By turning the dial 3 so that a part indicated by “reproduction mark” indicative of the reproduction mode comes to the predetermined position (the triangle mark MT in FIG. 2), the reproduction mode can be set.

The dial 3 can be also used to accept an operation of turning on/off a power source. That is, the dial 3 can be also referred to as a power source operating part. Concretely, by turning the dial 3 so that a part indicated as “OFF” comes to the predetermined position (the triangle mark MT in FIG. 2), an operation of turning off the power source (power source turning off operation) is performed.

On the rear face of the digital camera 1, the LCD 5 for displaying a live view before the image capturing operation and reproducing and displaying a recorded image and an electronic view finder (hereinafter, referred to as EVF) 4 are provided. On each of the LCD 5 and EVF 4, a color image is displayed. In the following description, a case where each of the LCD 5 and the EVF 4 has 320×240 display pixels will be taken as an example.

On the rear face of the digital camera 1, a menu button 6 is provided. For example, when the menu button 6 is depressed and released (hereinafter, simply expressed as “depressed”) in the image capturing mode, various menu screens for setting various image capturing conditions are displayed on the LCD 5. On the rear face of the digital camera 1, a control button 7 constructed by cross cursor buttons 7U, 7D, 7L and 7R for moving the display cursor on the LCD 5 in four ways and a decision button 7C provided in the center of the cross cursor buttons is provided. By using the menu button 6 and the control button 7, an operation of setting various image capturing parameters is performed. A setting state of the various image capturing parameters is displayed on a data panel 8 disposed on the top face of the digital camera 1. On the rear face of the digital camera 1, a switch button 13 is provided for switching information (particularly, a display state of captured information) displayed on the LCD 5 at the time of displaying a live view.

Further, on a side face of the digital camera 1, a function operation unit 11 is provided for performing an operation regarding a setting state of the digital camera 1. The function operation unit 11 is constructed by a function button 11a provided in the center and a function dial 11b provided so as to be turnable. Below the function operation unit 11, a focus mode switching button 12 is provided for switching a focus mode between an auto-focus mode and a manual-focus mode.

In a side face of the digital camera 1, an insertion port of a memory card 90 is provided as a removable (attachable/detachable) recording medium. Image data obtained by the image capturing operation is recorded in the memory card 90 which is set in the insertion port.

A microphone 14 for recording sound is provided on the front face of the digital camera 1. Sound data captured by the microphone 14 is added to moving image data or the like and stored. On the rear face of the digital camera 1, a speaker 15 for sound reproduction is provided. The speaker 15 is used, for example, for sound output of sound data attached to the moving image data.

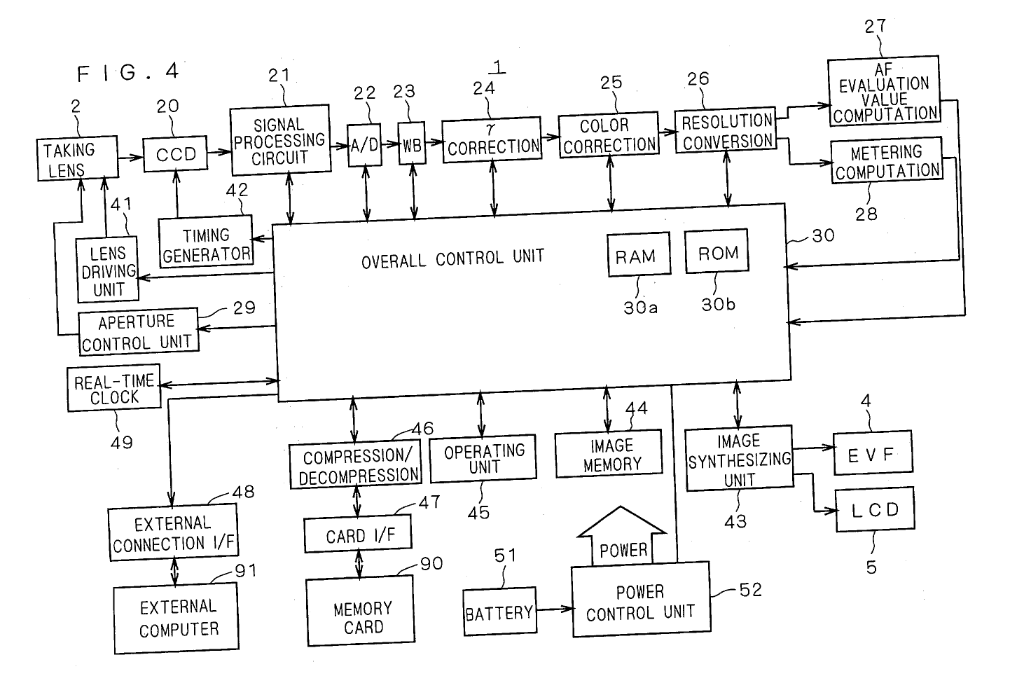

The internal configuration of the digital camera 1 will now be described. FIG. 4 is a block diagram showing an internal function of the digital camera 1.

The taking lens 2 is driven by a lens driving unit 41 and is constructed to adjust a focus state of an image formed on a CCD (Charge Coupled Device) sensor (also referred to as CCD image capturing device) 20. When the auto-focus is set, in accordance with a contrast method (hill-climbing method) using a captured image, a lens driving amount of the taking lens 2 is determined by an overall control unit 30. On the basis of the lens driving amount, the taking lens 2 is driven. On the other hand, when a manual-focus is set, a lens driving amount is determined according to an operation amount of the control button 7 by the user, and the taking lens 2 is driven on the basis of the lens driving amount.

The CCD image capturing device 20 functions as an image capturing part for capturing an image of a subject and generating an electronic image signal. The CCD image capturing device 20 has, for example, 2576×1936 pixels, photoelectrically converts an optical image of the subject formed by the taking lens 2 into image signals of color components of R (red), G (green) and B (blue) on a pixel unit basis (a signal constructed by a signal sequence of pixel signals received by pixels) and outputs the image signals. A timing generator 42 generates various timing pulses for controlling driving of the CCD image capturing device 20.

Herein, it can be also expressed that the taking lens 2 and the CCD image capturing device 20 for capturing a subject image from the taking lens 2 construct a single image capturing unit. Although a single image capturing unit of a one-chip type having a single CCD image capturing device 20 is illustrated here, the present invention is not limited thereto. For example, a digital camera may have a single image capturing unit of a 3-chip type, the unit capturing a subject image from the taking lens 2 by its three CCD image capturing devices.

An image signal obtained from the CCD image capturing device 20 is supplied to a signal processing circuit 21. In the signal processing circuit 21, a predetermined analog signal process is performed on the image signal (analog signal). The signal processing circuit 21 has a correlated double sampling circuit (CDS) and an auto gain control circuit (AGC). A process of reducing noise in an image signal is performed by the correlated double sampling circuit and the gain is adjusted by the auto gain control circuit, thereby adjusting the level of an image signal.

An A/D converter 22 converts each pixel signal in an image signal to a 12-bit digital signal. The A/D converter 22 converts each pixel signal (analog signal) to a 12-bit digital signal on the basis of a clock for A/D conversion inputted from the overall control unit 30. The digital signal obtained by the conversion is temporarily stored as image data into an image memory 44. On the image data stored in the image memory 44, respective processes are performed by a WB circuit 23, a γ correction circuit 24, a color correcting unit 25, a resolution converting unit 26, a compressing/decompressing unit 46 and the like each of which will be described below. The processed image data is stored again in the image memory 44 or transferred to another processing unit in accordance with each process.

The WB (White Balance) circuit 23 shifts the level of each of the color components of R, G and B. The WB circuit 23 shifts the level of each of the color components of R, G and B by using a level shifting table stored in the overall control unit 30. The parameter (gradient of a characteristic) of each color component in the level shifting table is automatically or manually set for each captured image by the overall control unit 30. The γ correction circuit 24 corrects the tone of pixel data.

The color correcting unit 25 performs color correction on image data which is supplied from the γ correcting circuit 24 on the basis of parameters regarding color correction set by the user and converts color information expressed in the RGB color space to color information expressed in the YCrCb color space. By the calorimetric system conversion, a luminance component value Y is obtained with respect to all of pixels.

The resolution converting unit 26 performs predetermined resolution conversion on the image data obtained from the CCD image capturing device 20.

An AF evaluation value computing unit 27 functions when the shutter start button 9 is touched by the user to perform an evaluation value computing operation for carrying out an auto-focus control of the contrast method. A sum of differential absolute values between two pixels neighboring in the horizontal direction with respect to image components corresponding to an AF evaluation area is calculated as an evaluation value for AF. The evaluation value for AF calculated by the AF evaluation value computing unit 27 is outputted to the overall control unit 30 and the auto-focus control is realized.

A metering computing unit 28 divides image data outputted from the resolution converting unit 26 into a plurality of blocks and calculates an evaluation value for AE on the basis of a representative luminance value of each block. The evaluation value for AE calculated by the metering computing unit 28 is outputted to the overall control unit 30 and used for an automatic exposure control in the overall control unit 30.

An aperture control unit 29 adjusts an aperture (aperture value) in the taking lens 2 under control of the overall control unit 30.

The image memory 44 is a memory for temporarily storing image data obtained by the CCD image capturing device 20 in an image capturing operation and subjected to the image processes. The image memory 44 has a storage capacity of, for example, several frames.

A card interface (I/F) 47 is an interface used for writing/reading image data to/from the memory card 90 inserted into the insertion port in a side face of the digital camera 1. At the time of reading/writing image data from/to the memory card 90, an image data compressing/decompressing process is performed, for example, in the JPEG method in the compressing/decompressing unit 46. An external connection interface (I/F) 48 is an interface for enabling communication to be performed with an external computer 91 via a communication cable or the like and is realized by an interface for communication conformed with, for example, the USB standard or the like. A control program recorded in the memory card 90 or a recording medium such as a CD-ROM which is set in the external computer 91 can be loaded into a RAM 30a or a ROM 30b of the overall control unit 30 via the card I/F 47 and the external connection I/F 48. When the program is executed in the overall control unit 30, various functions are realized.

An operation unit 45 is an operation unit including the dial 3, menu button 6, control button 7, shutter start button 9, function operation unit 11, focus mode switching button 12, switch button 13 and the like and is used when the user performs an operation of changing the setting state of the digital camera 1 or an image capturing operation.

A real-time clock 49 is a so-called clock unit. By a clock function of the real-time clock 49, the digital camera 1 can recognize the present time.

Further, the digital camera 1 uses a battery 51 as a driving source. As the battery 51, for example, four AA cells which are connected in series can be used. A power supply from the battery 51 to each of the processing units in the digital camera 1 is controlled by a power control unit 52.

The overall control unit 30 takes the form of a microcomputer having therein the RAM 30a and ROM 30b. When the microcomputer executes a predetermined program, the overall control unit 30 functions as a controller for controlling the components in a centralized manner. The ROM 30b is an electrically rewritable nonvolatile memory.

In the image capturing mode, the overall control unit 30 instructs a driving mode of driving the CCD image capturing device 20 to the timing generator. Particularly, when the user does not operate the shutter start button 9, the overall control unit 30 instructs the timing generator so as to repeat the image capturing operation in the CCD image capturing device 20 in order to obtain a live view image. Consequently, an image for live view display (live view image) is obtained in the CCD image capturing device 20.

The overall control unit 30 has a function of performing various controls such as the focus control, exposure control, white balance control and the like, each of which will be described below, in a centralized manner.

### A2. Operation

### General Operation

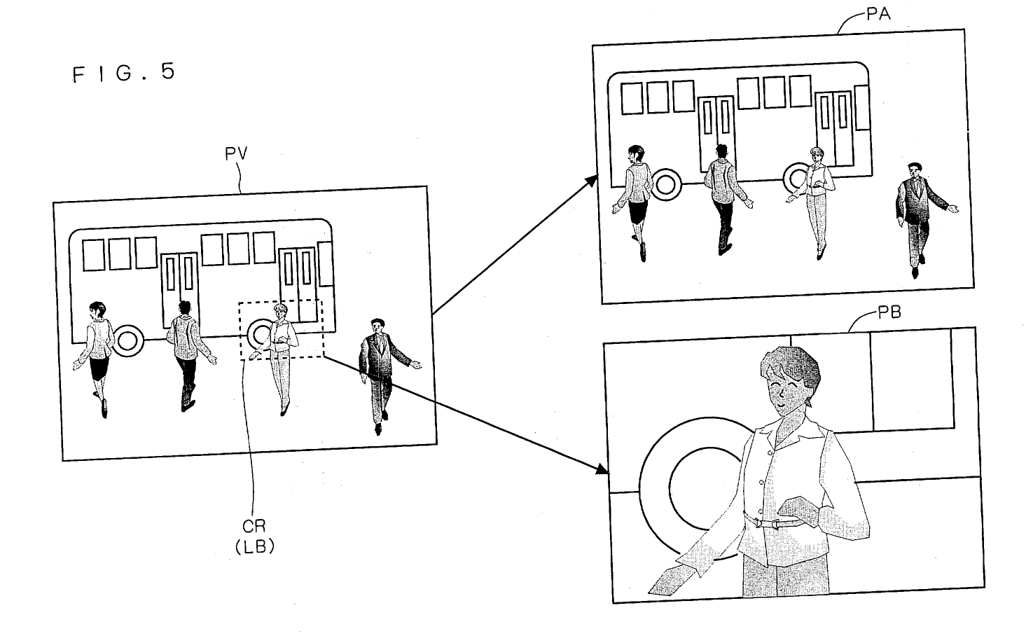

A moving image capturing operation in the digital camera 1, more particularly, an image capturing operation of capturing a plurality of moving images of different fields of view will now be described. By the operation, for example, a plurality of image data PA and PB of different fields of view (hereinafter, also simply referred to as images PA and PB) as shown in FIG. 5 can be obtained. FIG. 5 is a conceptual diagram showing the relationship among a live view image PV showing a whole image capturing range of the CCD image capturing device 20, a recording image PA corresponding to the whole image capturing range, and a recording image PB corresponding to a partial area of the whole image capturing range.

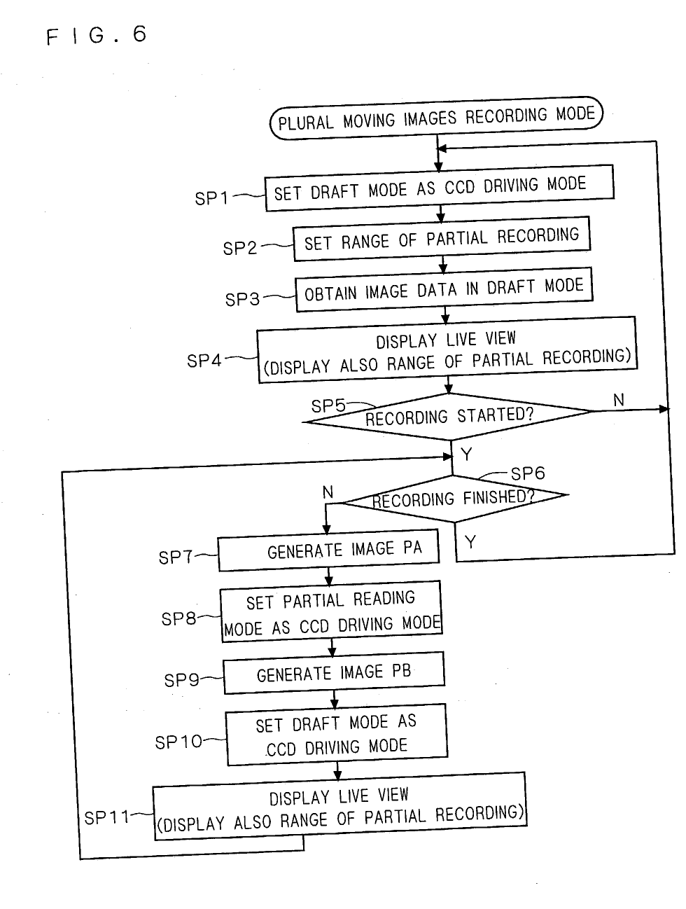

FIG. 6 is a flowchart showing the operations of the digital camera 1. In the following, according to the flowchart of FIG. 6, the operations in a plural moving images recording mode (which will be described later) of the digital camera 1 will be described. Prior to the description, an explanation will be given about some driving modes of the CCD image capturing device 20 (reading mode of the CCD image capturing device 20) and images read and generated in the respective driving modes.

The CCD image capturing device 20 has, as its driving modes (reading modes), three modes of a “global image capturing mode”, a “draft mode”, and a “partial reading mode”. The overall control unit 30 selects a specific mode from the reading modes and designates the selected mode to the timing generator 42. The timing generator 42 drives the CCD image capturing device 20 in accordance with the designation.

The “global image capturing mode” is a mode of reading image signals from a whole frame image (all of 2576×1936 pixels) as an object to be read. The mode is used at the time of generating a still image for recording.

The “draft mode” is a mode of reading image signals while skipping some of the signals. The draft mode is used at the time of generating an image for preview (also referred to as live view) before capturing a still image or a moving image.

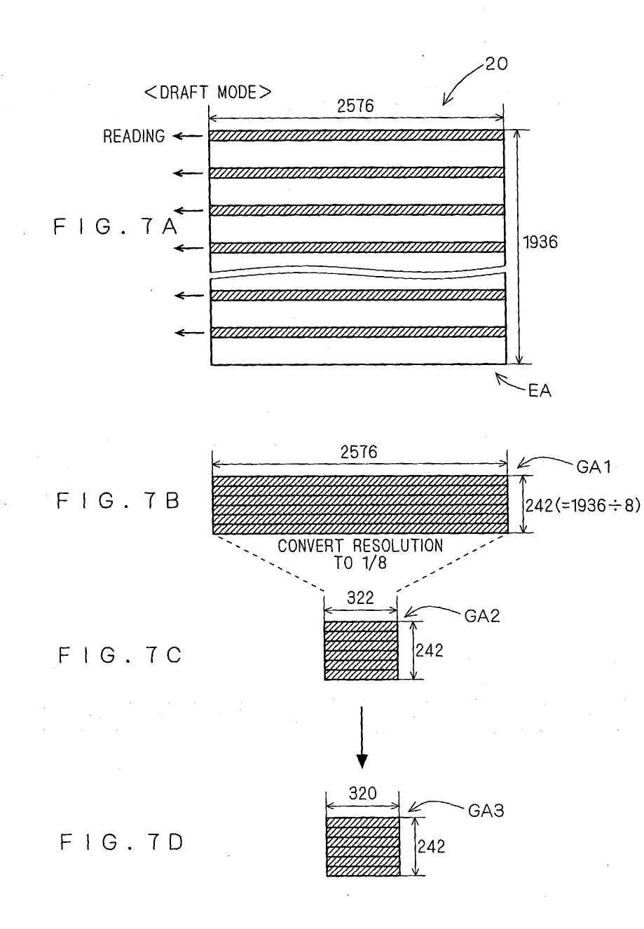

As shown in FIGS. 7A and 7B, in the draft mode, at the time of reading pixel images of a horizontal line from the CCD image capturing device 20 having 2576 pixels in the horizontal direction and 1936 pixels in the vertical direction, the CCD image capturing device 20 is driven so as to read one line in every eight lines. That is, in the draft mode, an image is read while reducing 1936 horizontal lines to ⅛. As a result, an image GA1 outputted from the CCD image capturing device 20 in the draft mode is constructed by 2576×242 pixels as shown in FIG. 7B.

After that, the resolution converting unit 26 performs predetermined resolution conversion on the image GA1 to reduce the number of pixels in the horizontal direction to ⅛, thereby obtaining an image GA2 constructed by 322×242 pixels as shown in FIG. 7C. Further, the resolution converting unit 26 eliminates a pixel line having a width of one pixel from each of the upper, lower, right and left ends, thereby obtaining an image GA3 constructed by 320×240 pixels as shown in FIG. 7D.

The image GA3 is an image of which field of view is the whole image capturing area of the CCD image capturing device 20 (whole image capturing range) EA (see FIG. 7A), and has a size adapted to the number of pixels displayed on the LCD 5. The image GA3 can be also expressed as an image adapted to the area EA (the whole image capturing range of the CCD image capturing device 20). In the first embodiment, the image GA3 is used as the image PA as one of two images for recording and is also used as a live-view image PV.

The “partial reading mode” is a mode of reading adjacent horizontal lines in a part of the whole image capturing range of the CCD image capturing device 20. For example, a pixel block constructed by a predetermined number (242) of continuous horizontal lines can be read as an image GB1. The reading start position and/or the reading end position are designated on the basis of an instruction from the overall control unit 30.

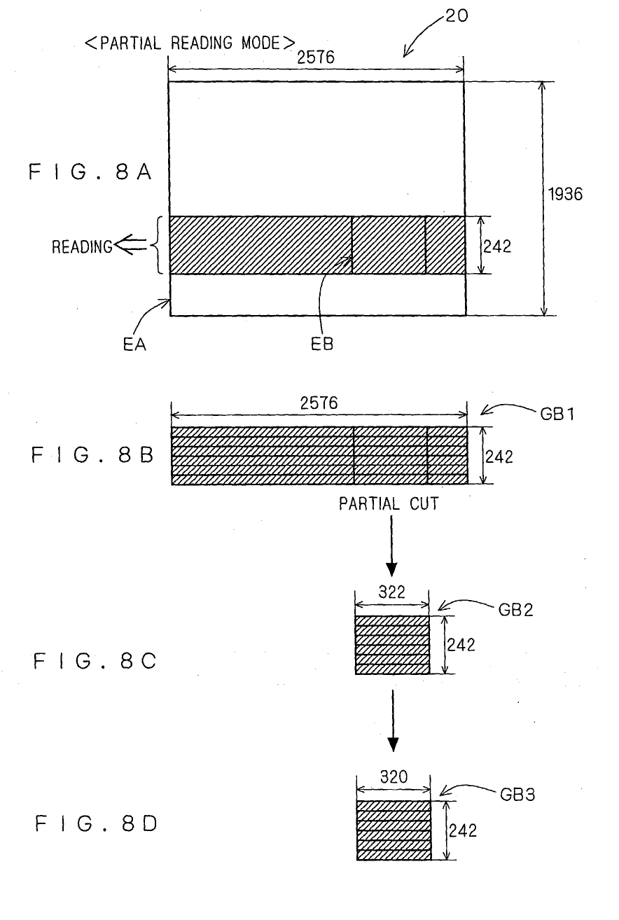

Concretely, as shown in FIGS. 8A and 8B, in the partial reading mode, pixel signals of continuous 242 horizontal lines starting from a predetermined position (number) are read from the CCD image capturing device 20 having 2576 pixels in the horizontal direction and 1936 pixels in the vertical direction, thereby obtaining an image GB1 constructed by 2576×242 pixels.

After that, the resolution converting unit 26 cuts out a pixel block in a designated position from the image GB1, thereby obtaining an image GB2 constructed by 322×242 pixels as shown in FIG. 8C. Further, the resolution converting unit 26 eliminates a pixel line having a width of one pixel from each of the upper, lower, right and left ends, thereby obtaining an image GB3 constructed by 320×240 pixels as shown in FIG. 8D.

The image GB3 is an image of which field of view is an area EB as a part of the whole image pickup area (whole image capturing range) EA of the CCD image capturing device 20. The area EB is an area included in the area EA and the image GB3 can be expressed as an image corresponding to the area EB. The image GB3 has the same size as that of the image GA3. In the first embodiment, the image GB3 is used as an image PB as one of two images for recording.

The operation of the digital camera 1 will now be described in accordance with the flowchart of FIG. 6.

The digital camera 1 has, as “image capturing modes”, a “still image recording mode” and a “moving image recording mode”. The “moving image recording mode” has, as its sub modes, a “normal moving image recording mode” of recording a single moving image and a “plural moving images recording mode” for recording a plurality of moving images. The plural moving images recording mode is a mode of capturing a plurality of moving images of different fields of view (or from different angles in a broad sense), so that it can be also referred to as a multi moving image capturing mode, multi-angle image capturing mode or the like.

FIG. 6 is based on a precondition that the “moving image recording mode” is set as the “image capturing mode” and the “plural moving images recording mode” is preliminarily selected as a sub mode of the “moving image recording mode” by means of predetermined menu operation, that is, the digital camera 1 is preset so as to operate in the “plural moving images recording mode”.

Herein, description will be given of a case of reading a plurality of images while switching the driving method of the CCD image capturing device 20. Concretely, description will be given of a case of reading images by alternately using two driving modes (also referred to as reading modes) of the CCD image capturing device 20, which are specifically the “draft mode” and the “partial reading mode”, and recording a plurality of images (moving images).

First, in steps SP1 to SP5, a preparing operation for capturing a moving image is performed.

Concretely, in step SP1, the overall control unit 30 sets the timing generator 42 so that the draft mode is set as the reading mode of the CCD image capturing device 20. By the control of the timing generator 42 based on the setting, the CCD image capturing device 20 is driven in the draft mode in a following step SP3.

In step SP2, the image capturing range of the partial image PB (FIG. 5) is set. Concretely, in an initial state, the image capturing range of the partial image PB is set in the center of the whole image capturing range. In a following step SP4, the image capturing range (border) of the image PB is displayed on the live view image PV. After that, the operator designates the position of the partial image PB in the whole image capturing range by moving a rectangular cursor CR on the live view image PV shown in FIG. 5 to up, down, right and left by using the control button 7. The digital camera 1 determines the image capturing range of the image PB in step SP2 on the basis of the designation of the operator. In the embodiment, the size of the image PB is fixed to a predetermined size and only the position of the image PB is changed. Alternately, the size of the image PB may be changed.

In step SP3, the image GA1 corresponding to the whole image capturing range of the CCD image capturing device 20 is read from the CCD image capturing device 20 in the draft mode. After that, various image processes are performed on the image GA1 by the signal processing circuit 21, A/D converter 22, WB circuit 23, y correction circuit 24, color correcting unit 25, resolution converting unit 26 and the like, thereby obtaining the image GA3.

In step SP4, the image GA3 is displayed as the live view image PV on the LCD 5. To be more accurate, the live view image PV is displayed as an image obtained by superimposing a rectangular figure (rectangular cursor CR) of a predetermined size surrounded by a broken line LB on the image GA3 (image PA) as shown in FIG. 5. In the live view display, the area designated as the image capturing range of the image PB is displayed as an area surrounded by the broken line LB by using the rectangular cursor CR, so that the image capturing range of the partial image PB as one of a plurality of (two in this case) images to be recorded can be grasped more easily.

In step SP5, whether an instruction to start recording (recording start instruction) has been inputted or not is determined. Concretely, whether the shutter start button 9 enters the depressed state S2 or not is determined. When it is determined that the shutter start button 9 has not entered the depressed state S2, it is regarded that the recording start instruction has not been inputted yet and the processes in steps SP1, SP2, SP3, SP4 and SP5 are repeatedly performed. On the other hand, when it is determined that the shutter start button 9 enters the depressed state S2, it is regarded that the recording start instruction is received and the program advances to step SP6 and subsequent steps.

In steps SP6 to SP11, a moving image capturing operation is performed.

In step SP6, a recording end determining process is performed. When it is determined that the shutter start button 9 enters again the depressed state S2, it is regarded that an instruction to finish recording (recording end instruction) is received, and recording of a moving image which will be described later is finished. On the other hand, when it is determined in step SP6 that the recording end instruction is not received, the program advances to step SP7 and subsequent steps, and the moving image capturing process is continued.

In step SP7, the image PA is generated. Concretely, with respect to the first frame, the image GA3 of the frame is generated already in step SP3, so that the image GA3 may be used as it is as the image PA. On the other hand, with respect to frames other than the first frame, after changing the mode to the draft mode by the setting change in step SP10 (which will be described later), various image processes by the signal processing circuit 21, A/D converter 22, WB circuit 23, γ correction circuit 24, color correcting unit 25, resolution converting unit 26 and the like are performed on the image GA1 read from the CCD image capturing device 20, thereby generating the image GA3. It is sufficient to use the newly generated image GA3 as the image PA.

The image GA3 is an image corresponding to the whole image capturing range of the CCD image capturing device 20 and is obtained as the image PA as one of the plurality of recording images. The overall control unit 30 records the image PA into the memory card 90.

In step SP8, the overall control unit 30 sets the timing generator 42 so that the partial reading mode is set as the reading mode of the CCD image capturing device 20. By the control of the timing generator 42 based on the setting, the CCD image capturing device 20 is driven in the partial reading mode in the following step SP9.

In step SP9, the image PB is generated. Concretely, various image processes by the signal processing circuit 21, A/D converter 22, WB circuit 23, γ correction circuit 24, color correcting unit 25, resolution converting unit 26 and the like are performed on the image GB1 read in the partial reading mode, thereby generating the image GB3. The image GB3 is obtained as the other image PB out of the plurality of (two in this case) recording images. The overall control unit 30 records the image PB into the memory card 90.

After that, in step SP10, as the reading mode of the CCD image capturing device 20, the draft mode is set again. By the control of the timing generator 42 based on the setting, the CCD image capturing device 20 is driven in the draft mode in step SP7.

In step SP11, the live view image PV is displayed on the LCD 5. In the live view display, the border of an area designated as the image capturing range of the image PB is continuously explicitly shown by using the rectangular cursor CR (broken line LB). In other words, in a state where the positional relationship between the whole area EA and the area EB in the CCD image capturing device 20 is shown, the live view image PV including the images PA and PB is displayed. Since the positional relationship between the areas EA and EB is shown, the operator can clearly grasp the positional relation of the images PA and PB. Particularly, in a state where the border of the area EB included in the area EA is displayed by using the broken line LB, the images PA and PB corresponding to the areas EA and EB are displayed. Therefore, the image capturing range of the partial image PB as one of the plurality of images PA and PB to be recorded can be grasped more easily. Thus, operability is high.

After that, until it is determined in step SP6 that the recording end instruction is inputted, the processes in steps SP7, SP8, SP9, SP10 and SP11 are repeatedly executed.

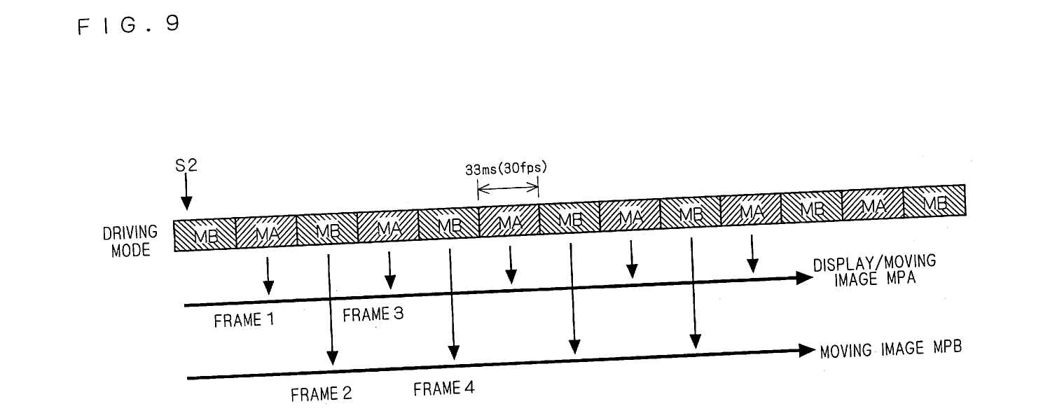

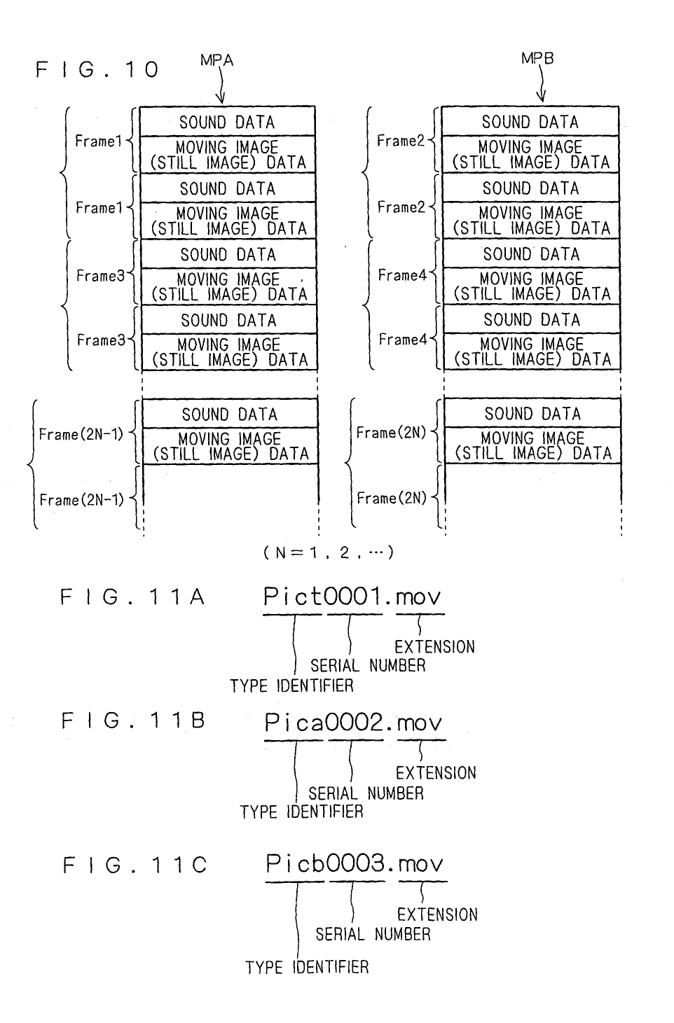

FIG. 9 is a timing chart showing the above-described operations along the time base. FIG. 9 shows a state where the draft mode and the partial reading mode are alternately used and a frame image is read from the CCD image capturing device 20 at 1/30 second (about 33 milliseconds) intervals. Concretely, the image of a first frame is the image PA read and generated in the draft mode MA, and the image of a second frame is the image PB read and generated in the partial reading mode MB. The image of a third frame is the image PA read and generated again in the draft mode MA, and the image of a fourth frame is the image PB read and generated in the partial reading mode MB. After that, similarly, images are read alternately in the draft mode MA and the partial reading mode MB, and the images PA and PB are alternately generated. A group of continuous images PA is recorded as a moving image file MPA, and a group of continuous images PB is recorded as a moving image file MPB. The moving image files MPA and MPB are recorded as moving image files which are different from each other into the memory card 90 (recording medium).

As described above, the digital camera 1 can alternately read (repeatedly in order) the images PA and PB from the CCD image capturing device 20 and record the images PA and PB. The images PA and PB are images captured almost at the same time and their fields of view are different from each other. The images PA and PB are images read from the same (single) image capturing unit (image capturing part) constructed by the taking lens 2 and the CCD image capturing device 20 or the like. Therefore, without necessity of preparing a plurality of cameras, the plurality of images PA and PB (moving images MPA and MPB) of different fields of view can be easily captured.

The images PA constructing the moving image file MPA and the images PB constructing the moving image file MPB are alternately transferred from the buffer memory (image memory 44) to the memory card 90 and alternately recorded, so that the capacity of the buffer memory can be suppressed. If the images are not alternately recorded, a plurality of image data pieces corresponding to one of areas (for example, image data of a few frames to hundreds of frames) have to be temporarily stored in the buffer memory. By alternately recording the images, it is unnecessary to temporarily store the plurality of image data into the buffer memory.

### Moving Image Data

FIG. 10 shows a frame structure of each of the moving image file MPA and the moving image file MPB. The moving image file MPA is moving image data having the images PA of odd-numbered frames as elements, and the moving image file MPB is moving image data having the images PB of even-numbered frames as elements.

Herein, since the frame rate of the moving image files MPA and MPB is set to 30 FPS (frame per second), each frame image is recorded continuously twice.

Concretely, with respect to the moving image file MPA, the image PA of the first frame in the CCD image capturing device 20 is recorded continuously twice as the first and second frames in the moving image file MPA. The image PA of the third frame in the CCD image capturing device 20 is recorded continuously twice as the third and fourth frames in the moving image file MPA. The moving image file MPB is similarly recorded.

The present invention is not limited to the above. A moving image file MPA of 15 FPS may be generated by sequentially recording images PA obtained in time series without overlapping in accordance with the obtaining order. The moving image file MPB is generated similarly.

As sound data, sound collected by the single microphone 14 (FIG. 1) of the digital camera 1 is commonly used by the moving image files MPA and MPB. More concretely, the digital camera 1 adds the same sound data obtained by the microphone 14 (recording unit) to each of the moving image files MPA and MPB, thereby generating a plurality of moving image files MPA and MPB with sound data, and the generated moving image files MPA and MPB are recorded into the memory card 90. That is, the sound data of the moving image file MPA and that of the moving image file MPB is the same. As described above, at the time of generating a plurality of moving image files with sound data, a single recording unit can be commonly used.

The moving image files MPA and MPB are recorded as separate files under different names into the same memory card 90 (single recording medium).

FIGS. 11A to 11C describe a rule of assigning a file name. There is assumed a case of recording one moving image file by a single image capturing operation in the normal moving image recording mode and, then, recording two moving image files by a single image capturing operation in the above-described plural moving images recording mode. In any of the moving image files, an extension “mov” indicates a moving image.

FIG. 11A shows the name of a moving image file captured in the initial normal moving image recording mode. To the moving image file, the name of “Pict0001.mov” (the fourth character is “t”) is assigned. The first four characters “Pict” indicate that the image is a moving image obtained in the normal moving image recording mode. The following four characters indicate a file number which is incremented one by one in an image capturing order irrespective of the mode and the image capturing area. Herein, since the file is the initial file, “0001” is assigned.

FIG. 11B shows the name of one of two moving image files obtained in the plural moving images recording mode. To the moving image file, the name of “Pica0002.mov” is assigned. The first four characters “Pica” (the fourth character is “a”) indicate that the moving image corresponds to the area EA in the plural moving images recording mode. The following four characters indicative of the file number are “0002”, obtained by automatically incrementing the file number of the first file by one.

FIG. 11C shows the name of the other moving image file in the two moving image files captured in the plural moving images recording mode. To the moving image file, the name “Picb0003.mov” is assigned. The first four characters “Picb” (the fourth character is “b”) indicate that the moving image corresponds to the area EB in the plural moving images recording mode. The following four characters indicative of the file number are “0003”, obtained by automatically incrementing the file number by one.

As described above, image data corresponding to the plurality of areas EA and EB in the CCD image capturing device 20 is recorded as a plurality of moving image files which are different from each other in a state where their file names are related to each other. Therefore, the operator can easily understand the relation between the files, so that confusion can be prevented.

Particularly, the file name has an identification part (herein, the first four characters (particularly, the fourth character)) for identifying an area to be captured, so that the operator can easily identify the area to be captured in each moving image file (more concretely, whether the area to be captured is the area EA or EB). The first four characters in the file name also have the function of identifying the recording mode of each moving image file.

The file number part (herein, four characters from the fifth character to the eighth character) of the file name of a moving image file has a unique serial number unconditionally assigned to the moving image file irrespective of the area to be captured. Therefore, the same file number is not assigned to files of different areas to be captured. Consequently, whether moving image files are different from each other or not can be determined by detecting whether the file numbers are different from each other or not. That is, there is little fear of confusion. It can be easily identified that files of continuous numbers are related to each other.

Further, continuous numbers are assigned to a plurality of moving image files obtained by the same image capturing operation. The smallest number is given to a moving image file of which area to be captured is a specific area (herein, the area EA) out of the plurality of moving image files obtained by the single image capturing operation. Whether the area to be captured is the specified area (herein, the area EA) or not can be identified by a specific identifier (for example, “Pica” (the fourth character is “a”)). Therefore, a series of files having continuous numbers (2, 3) starting from the file number (herein, 2) of the file having the specific identifier (for example, “Pica”) can be recognized as a plurality of (herein, two) moving image files obtained by a single image capturing operation in the plural moving images recording mode.

### AF Control, AE Control and AWB Control

Next, description will be given of an auto-focus control (also abbreviated as AF control), automatic exposure control (also abbreviated as AE control), and automatic white balance control (also abbreviated as AWB control) in the plural moving images recording mode.

First, at the time of non-recording (for example, a loop from step SP1 to step SP5 in FIG. 6), the live view image PV based on the image GA3 read in the draft mode MA is displayed on the LCD 5. In order to adjust the live view image PV, the AF control, AE control and AWB control are performed. The AE control and AWB control are performed on the basis of evaluation values (an evaluation value for AE and an evaluation value for AWB) calculated by using the image GA3 in the draft mode MA. The AF control is performed on the basis of an evaluation value for AF calculated by using the image GB3 in the partial reading mode.

On the other hand, at the time of recording (for example, a loop from step SP6 to step SP11 in FIG. 6), the live view image PV based on the image GA3 (PA) in the draft mode MA is displayed on the LCD 5, and the image GA3 (image PA) in the draft mode MA and the image GB3 (image PB) in the partial reading mode MB are alternately read and alternately recorded. For adjustment of the images PA and PB for recording, the AF control, AE control and AWB control are performed.

The AE control on both of the images PA and PB is performed on the basis of the evaluation values (evaluation value for AE and evaluation value for AWB) calculated by using the image GA3 in the draft mode MA. However, since the fields of view of the images PA and PB are different from each other (in other words, the image capturing ranges of the images PA and PB are different from each other), it is preferable to use evaluation values of different blocks corresponding to the respective image capturing ranges.

First, the AE control on the image PA will be described.

The AE control on the image PA is performed on the basis of a result of metering computation on the whole image GA3. More specifically, the metering computing unit 28 divides the image GA3 (PA) outputted from the resolution converting unit 26 into a plurality of blocks (also referred to as “metering blocks”) and calculates an evaluation value for AE on the basis of a representative luminance value of each block.

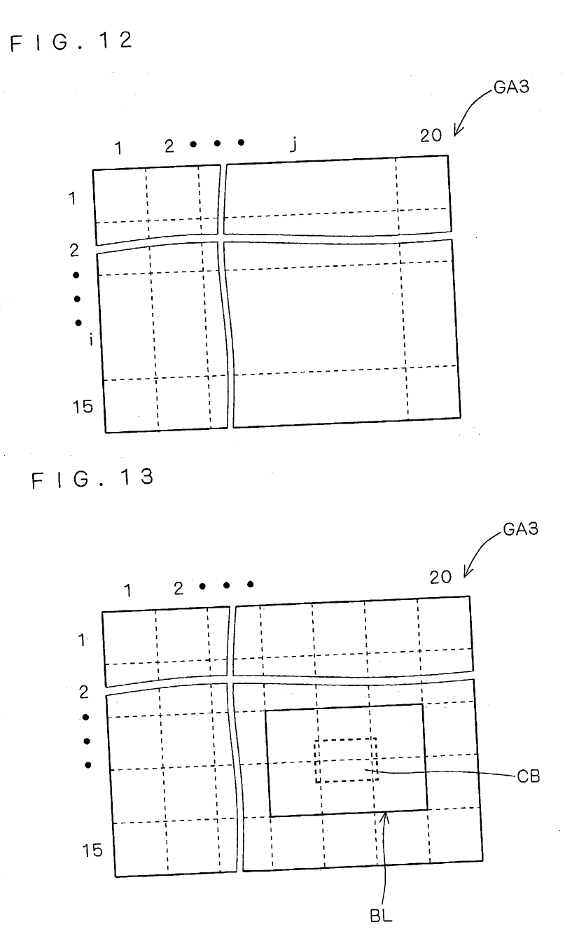

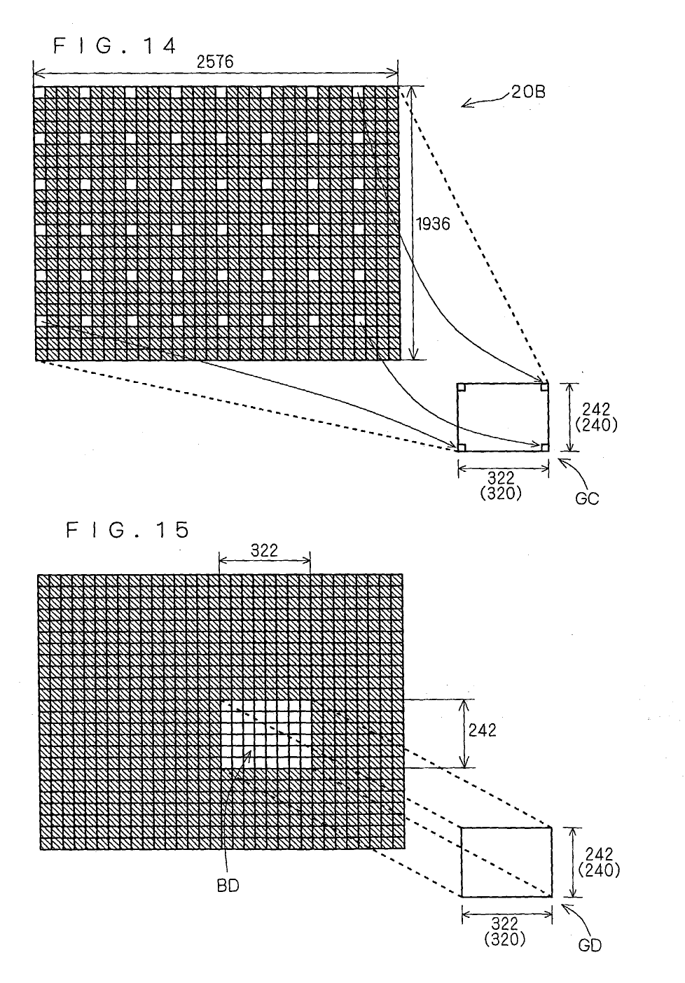

FIG. 12 shows an example of a metering block. When the image GA3 is inputted, the metering computing unit 28 partitions (divides) the image GA3 (PA) into 20 pieces in the horizontal direction and 15 pieces in the vertical direction. As a result, the image GA3 having a size of 320 pixels in the horizontal direction and 240 pixels in the vertical direction is partitioned to total 300 (=20×15) metering blocks, and each metering block has a size of 16 pixels (in the horizontal direction) and 16 pixels (in the vertical direction). The metering computing unit 28 adds luminance values of a plurality of pixels included in each block, thereby calculating a representative luminance value of each block. As the luminance value of each pixel, a weighting addition value (Y component value) of each of color component values of R (red), G (green) and B (blue) may be used or a value of one (for example, a G component) of the color components may be used.

A product in multiplication between the representative luminance value obtained from each block and a weighting factor associated with each block is obtained, and products obtained with respect to all of blocks (300 blocks) are accumulated, thereby computing an evaluation value for AE. AE controls of various methods such as spot metering, center-weighted metering, averaging metering and the like exist. By changing the weighting factor in accordance with each method, an evaluation value for AE according to each method can be calculated. For example, by setting weighting factors to the same value, an evaluation value for AE of the averaging metering method can be calculated.

The metering computing unit 28 outputs the calculated evaluation value for AE to the overall control unit 30. The overall control unit 30 determines image capturing parameters (concretely, shutter speed and aperture) for setting an exposure state at the time of capturing the next frame image (image PA) to a proper state by using the evaluation value for AE. After that, the next frame image PA is obtained with the determined image capturing parameters.

It is sufficient to perform the AE control at the time of non-recording (steps SP1 to SP5) in a manner similar to the AE control on the image PA at the time of recording.

The AE control on the image PB will now be described.

The AE control on the image PB is performed on the basis of the image GA3 in a manner similar to the AE control on the image PA. However, as shown in FIG. 13, an evaluation value for AE is calculated with respect to a part of the plurality of blocks obtained by partitioning the image GA3, concretely, with respect to only blocks including the area corresponding to the image PB. In FIG. 13, the evaluation value for AE is calculated on the basis of only six blocks (blocks surrounded by a bold line BL in FIG. 13) corresponding to the position of the image PB in the image PA out of the plurality of (300) blocks in the image GA3 (PA). The six blocks are blocks including the area CB corresponding to the position of the image PB in the image PA.

A product between the representative luminance value obtained from each block and a weighting factor associated with the block is calculated and products obtained from the six blocks are accumulated, thereby obtaining an evaluation value for AE. Herein, since the number of blocks is relatively small, the averaging metering method is employed, and a weighting factor such that the same weight is assigned to the blocks is used. As described above, the AE control may be performed in another method.

The metering computing unit 28 outputs the calculated evaluation value for AE to the overall control unit 30 and the overall control unit 30 determines image capturing parameters (concretely, shutter speed and aperture) for setting the exposure state at the time of capturing the next frame image (image PB) to a proper state by using the evaluation value for AE.

In such a manner, the control parameters in the AE control on the images PA and PB can be determined on the basis of the evaluation value for AE using one image GAS3 (PA) of the two. In this case, as compared with a case of determining the control parameters in the AE control on the images PA and PB also on the basis of the evaluation value for AE using the other image GB3 (PB), it is unnecessary to calculate the evaluation value for AE on the image GB3 (PB), so that the computation amount can be decreased. That is, efficiency is high.

Control parameters in the exposure control on the image PA are determined on the basis of the image PA, and control parameters in the exposure control on the image PB are determined on the basis of data in the area corresponding to the image capturing range of the image PB in the image data of the image PA. Therefore, the exposure control on the image PA can be carried out in accordance with the characteristics of the image PA and the exposure control on the image PB can be performed in accordance with the characteristics of the image PB. That is, the AE control according to the characteristics of each of the images PA and PB can be performed.

The AWB control will now be described. The AWB control on the images PA and PB is performed on the basis of evaluation values (evaluation value for AE and evaluation value for AWB) calculated by using the image GA3 in the draft mode MA in a manner similar to the AE control.

The metering computing unit 28 also functions as a color metering computing unit, makes each of the blocks in FIG. 12 function also as a color metering block, and calculates an evaluation value for AWB (Auto White Balance). The AWB control is performed on the basis of the evaluation value for AWB.

The evaluation value for AWB is an evaluation value for measuring the balance of three color components of R (red), G (green) and B (blue) in an image, and is obtained as a value indicative of a ratio of each of the three color components.

Since the fields of view of the images PA and PB are different from each other (in other words, the image capturing ranges of the images PA and PB are different from each other), it is preferable to use the evaluation value of a different block according to the image capturing range.

Concretely, with respect to the image PA, a value indicative of a ratio of each of the three color components can be obtained as an evaluation value for AWB from the whole range of the image GA3, that is, all of blocks in FIG. 12 as an objective region.

On the other hand, with respect to the image PB, a value indicative of a ratio of each of the three color components is calculated as an evaluation value for AWB on the basis of only six blocks (blocks surrounded by the bold line BL in FIG. 13) corresponding to the position of the image PB in the image PA out of the plurality of (300) blocks in the image GA3.

The calculated evaluation value for AWB is outputted to the overall control unit 30. The overall control unit 30 determines an image capturing parameter (concretely, a white balance gain) for setting the white balance at the time of capturing the next frame to a proper state by using the evaluation value for AWB. The WB circuit 23 performs an image process on the basis of the white balance gain determined for each of the images PA and PB at the time of capturing the next image PA or PB.

In such a manner, the evaluation value for AWB in the AWB control performed on each of the images PA and PB is calculated by using only the image GA3 (PA) as one of the images. As compared with the case of calculating the evaluation value for AWB using also the other image GB3, the computation amount can be decreased. That is, efficiency is high.

The control parameters in the white balance control on the image PA are determined on the basis of the image PA and the control parameters in the white balance control on the image PB are determined on the basis of data of the area corresponding to the image capturing range of the image PB in the image data of the image PA. Therefore, it becomes possible to perform the white balance control on the image PA in accordance with the characteristics of the image PA and perform the white balance control on the image PB in accordance with the characteristics of the image PB. That is, the AWB control according to the characteristics of each of the images PA and PB can be performed.

It is unnecessary to perform the AE control and the AWB control on all of frames but it is sufficient to perform the AE control and the AWB control at a rate of once every predetermined number of frames (for example, a rate of once every four frames).

Further, the AF control will be described. Herein, a so-called contrast method is used.

The AF control on the images PA and PB is performed on the basis of the evaluation value for AF calculated by using the image GB3 in the partial reading mode. Concretely, the sum of differential absolute values between two pixels neighboring in the horizontal direction in the image GB3 is calculated as the evaluation value for AF.

When the distances of the subject in the images PA and PB are different from each other, the focus position may be changed between the time of capturing the image PA and the time of capturing the image PB. However, time for driving the lens is required and a problem such as reduction in the frame rate occurs. Consequently, herein, it is assumed that the evaluation value for AF is calculated by using the partial image PB out of the two images PA and PB.

The reason why the image PB, not the image PA, is used is that the partial image PB is often a part to which attention is paid in the whole area of the image PA, and/or the pixel pitch of the image PB is eight times as high as the pixel pitch of the image PA, the depth of field (depth of focus) of the image PB is eight times as large as that of the image PA, and the like.

The evaluation value for AF calculated in such a manner is outputted to the overall control unit 30 and the auto-focus control is realized. For example, at the time of non-recording, the AF control is performed only in the case where the shutter start button 9 is touched by the user. It is sufficient to perform the AF control at predetermined time intervals at the time of recording.

As described above, also at the time of recording, the AF control on the images PA and PB can be performed on the basis of the evaluation value for AF only from the image GB3 (PB) as one of the images. Thus, as compared with the case of executing computation on the basis of also the evaluation value for AF from the other image GA3, the computation amount can be decreased. That is, efficiency is high.

### B. Second Embodiment

A second embodiment will now be described. A digital camera according to the second embodiment has a configuration similar to that of the digital camera according to the first embodiment except for the point that a CMOS (Complementary Metal Oxide Semiconductor) sensor 20B is used in place of the CCD sensor 20 as the image capturing device. In the following, the different point will be mainly described.

FIGS. 14 and 15 describe designation of a read pixel in the CMOS sensor (CMOS image capturing device) 20B. In the CMOS sensor 20B, it is unnecessary to read a horizontal line and/or a vertical line but a pixel in an arbitrary designated position can be read. Therefore, resolution conversion in the horizontal direction at the time of obtaining a moving image GC for recording is unnecessary.

Description will be given on assumption that the CMOS sensor 20B has 2576×1936 pixels.

At the time of obtaining a still image for recording, all of pixels (2576×1936 pixels) of the CMOS sensor 20B are read to generate a still image for recording.

On the other hand, at the time of obtaining a live view image, at the time of obtaining a moving image for recording, and the like, signals of some of all of the pixels are read to generate an image of a relatively small pixel size (for example, size of 320×240 pixels).

The image of such a relatively small pixel size is broadly divided into images of two types in accordance with the extracting method.

As shown in FIG. 14, one of the images of two types is an image GC indicating a state of the whole area of the CMOS sensor 20B, for example, which is obtained by reading pixels at intervals of a few pixels from the whole area of the CMOS sensor 20B. The conceptual diagram of FIG. 14 shows a state where a pixel is read every eight pixels in each of the vertical and horizontal directions from the CMOS sensor 20B to generate an image having a size of 322×242 pixels. After performing a predetermined image process, a pixel line having a width of one pixel is eliminated from each of the upper, lower, right and left ends, thereby generating the image GC having a size of 320×240 pixels which is the same as that in the first embodiment. The image GC is an image corresponding to the whole area of the image capturing range like the whole image PA of FIG. 5.

The other image is the image GD indicative of the state of a partial area extracted from the CMOS sensor 20B, for example, which is an image obtained by reading pixels of a pixel block area BD as a set of pixels adjacent to each other from the CMOS sensor 20B. The conceptual diagram of FIG. 15 shows a state where an image of 322×242 pixels which are continuous from a predetermined position (i, j) to (i+241, j+321) is read from the CMOS sensor 20B and subjected to a predetermined image process and, after that, a pixel line having a width of one pixel is eliminated from each of the upper, lower, right and left ends, thereby generating an image GD having a size of 320×240 pixels which is the same as that of the first embodiment. The image GD is an image corresponding to a partial area in the image capturing range like the partial image PB in FIG. 5

By changing the reading pixel position, the images GC and GD of which image capturing ranges are different from each other (of different fields of view) can be obtained.

While switching the designation position of the read pixel in the CMOS sensor 20B, the two images GC and GD are alternately read and alternately recorded.

By such an operation, a plurality of images of different fields of view can be easily captured.

Although the case of generating the image GC by pixels read at equal intervals in both the horizontal and vertical directions from the CMOS sensor 20B has been described in the second embodiment, the present invention is not limited thereto. For example, at the time of generating the image GC, pixels arranged at irregular intervals in the CMOS sensor 20B may be designated and read. Further, a horizontal position and a vertical position may be designated and read independent of each other.

### C. Third Embodiment

A third embodiment will be described with respect to a case of recording two “partial images”. The third embodiment is a modification of the first embodiment and the point different from the first embodiment will be mainly described below.

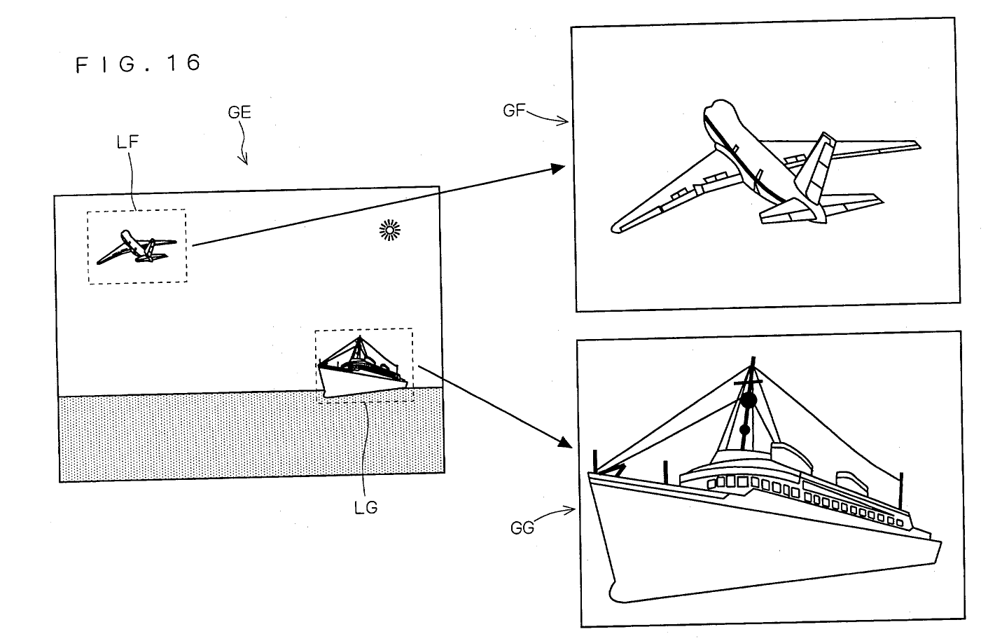

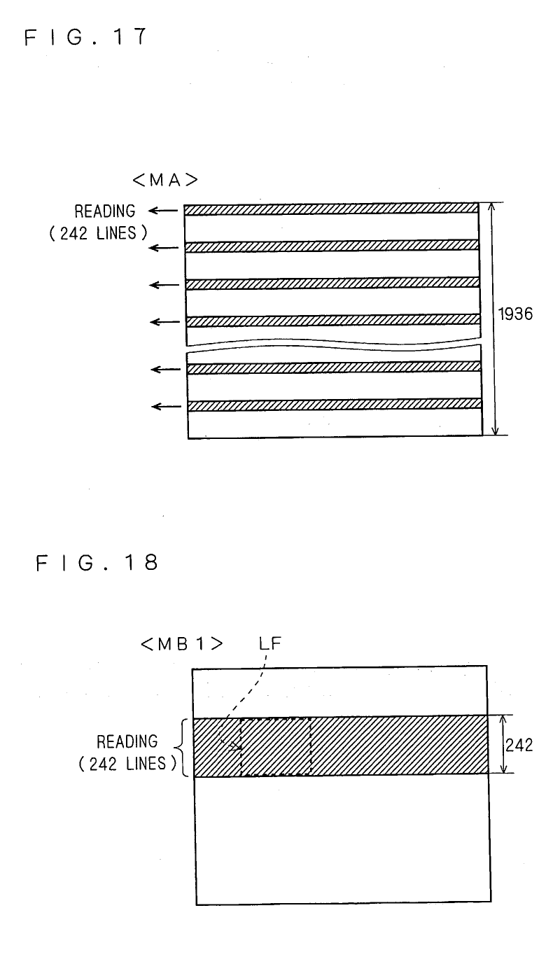

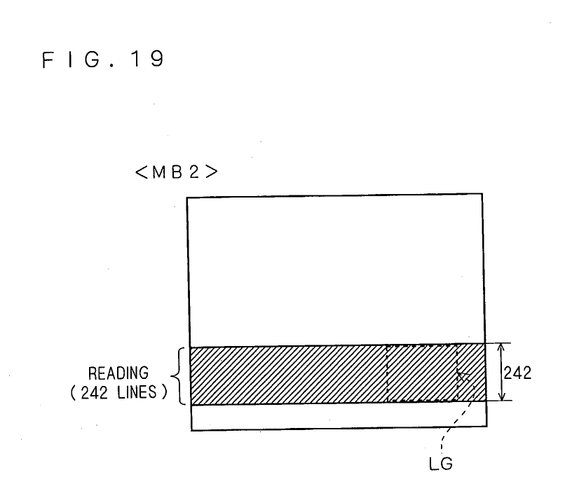

FIG. 16 shows the relationship between an image GE showing the whole image capturing range of the CCD image capturing device 20 and images GF and GG corresponding to partial areas LF and LG in the image GE. In the third embodiment, the two images GF and GG of different fields of view are captured as moving images which are different from each other.

FIGS. 17, 18 and 19 are conceptual diagrams showing a reading mode of the CCD image capturing device 20 at the time of obtaining the images GE, GF and GG, respectively.

FIG. 17 shows a reading mode (corresponding to the draft mode MA in the first embodiment) of obtaining the whole image GE. FIGS. 18 and 19 show a reading mode (corresponding to the partial reading mode MB in the first embodiment) of obtaining the partial images GF and GG, respectively.

The images GF and GG are read in the same reading mode but in a state where the positions of the horizontal lines to be read are different from each other. The horizontal lines to be read in FIG. 18 are positioned upper than the horizontal lines to be read in FIG. 19 for a reason that, as shown in FIG. 16, the image capturing range (area LF in FIG. 16) of the image GF exists relatively upper in the image GE than the image capturing area (area LG in FIG. 16) of the image GG. The images GF and GG are alternately read from the CCD image capturing device 20 while switching a read pixel designation vertical position (in other words, while switching the horizontal line to be read). In order to distinguish the reading mode of FIG. 18 and the reading mode of FIG. 19 from each other, the former mode is also referred to as a partial reading mode MB1 and the latter mode is also referred to as a partial reading mode MB2.

Images read in the modes of FIGS. 17 to 19 are subjected to various image processes and generated as images GE, GF and GG each having a predetermined size (for example, 320×240).

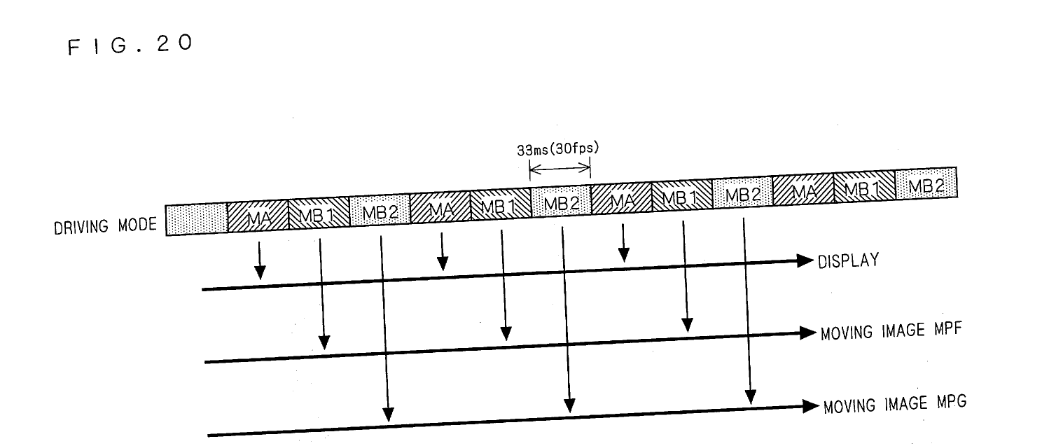

FIG. 20 is a timing chart showing operation in the third embodiment. FIG. 20 shows a state where the draft mode MA, partial reading mode MB1 and partial reading mode MB2 are repeatedly used sequentially (in turn) and frame images are read from the CCD image capturing device 20 at intervals of 1/30 second (about 33 milliseconds). Concretely, the image of the first frame is the image GE read and generated in the draft mode MA, the image of the second frame is the image GF read and generated in the partial reading mode MB1, and the image of the third frame is the image GG read and generated in the partial reading mode MB2. After that, also in the fourth and subsequent frames, the images GE, GF and GG are repeatedly read and generated sequentially (in this order).

The images GF and GG out of the generated images are alternately recorded in the memory card 90. A group of continuous images GF and a group of continuous images GG are recorded as separate moving image files MPF and MPG, respectively.

The general image GE is displayed as a live view image on the LCD 5. As shown in FIG. 16, in the LCD 5, the partial images GF and GG are displayed together with the general image GE including both of the areas of the partial images GF and GG, and the boundaries of the areas LF and LG corresponding to the partial images GF and GG, respectively, are displayed by broken lines. Therefore, the operator can easily grasp the positions in the image GE, of the areas corresponding to the images GF and GG partially recorded, and operability is high.

Although the image GE is not used as a recording image herein, the image GE as a general image may be further recorded. That is, the three images GE, GF and GG may be generated repeatedly in this order to record the three moving images.

The AE control, AWB control and AF control at the time of capturing partial images will now be described.

With respect to the AE control and AWB control, it is sufficient to perform the controls in a manner similar to the first embodiment. Specifically, at the time of recording, the evaluation value is computed on the basis of the image GE for all the images GE, GF and GG, and the AE control and the AWB control are performed on the basis of the evaluation values. For each of the images GF and GG, it is more preferable to obtain an evaluation value by using a block corresponding to each of the areas of the images GF and GG out of the plurality of blocks obtained by dividing the image GE.

For the AF control, it is sufficient to use, for example, both or one of the following two methods.

One of the methods is a method of performing an image capturing operation in accordance with the closer subject distance in the subject distances of the partial images GF and GG. The focus position of the taking lens 2 is changed so that focus is achieved on the relatively close subject. Generally, the depth of field is deep on the rear side of the position where in-focus is achieved, so that the possibility that the subjects of both of the partial images GF and GG enter in-focus can be increased.

The other method is a method of setting an aperture value to a relatively large value (to a state where the aperture is stopped down relatively) and capturing an image. By setting the aperture value to a relatively large value, the depth of field becomes a relatively large value, so that the possibility that the subjects of both of the partial images GF and GG come into in-focus becomes high. According to such an aperture control, the frequency of movement of focus in an optical system is reduced (ideally to zero) and, after that, the subjects of both the images GF and GG can come into in-focus. By decreasing the frequency of movement of focus, the image capturing interval can be set to be relatively short.

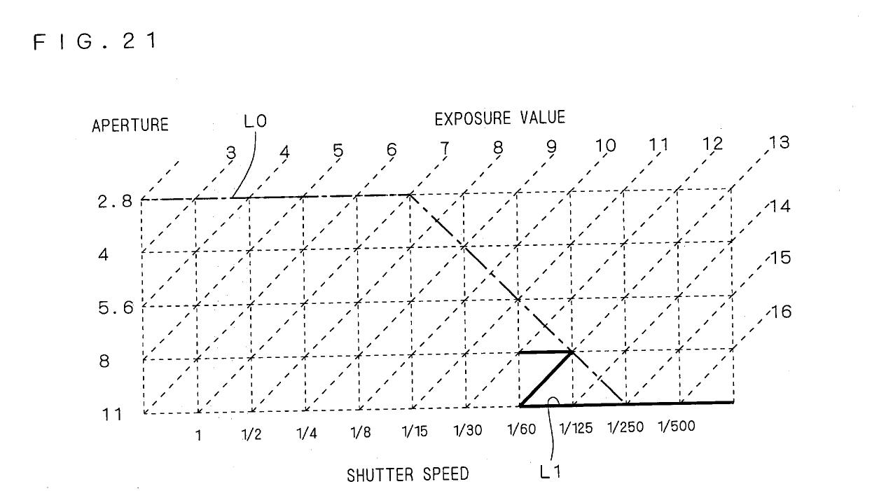

FIG. 21 shows an example of program lines for exposure control according to the APEX method of setting the aperture in such a manner. Concretely, a line L0 in FIG. 21 indicates a normal program line and a line L1 indicates a program line of setting a state where the aperture is stopped down as much as possible (concretely, the program line in which the aperture value (f-number) becomes equal to or larger than a predetermined value (8.0)).

In the program line L1, when the exposure value is a threshold value (13 in the figure) or larger, the aperture is set to be stopped downmost (11.0 in the f-number) and shutter speed is set. When the exposure value is smaller than the threshold value, the aperture value is set to a less stopped state (8.0 in the f-number) and shutter speed is set. Further, when the exposure value becomes smaller than a predetermined reference value (herein, 12), brightness shortage is determined, and moving image capturing in the plural moving images recording mode is inhibited.

For example, in the case where the exposure value is 12, the shutter speed is set to 1/60, and the aperture value (f-number) is set to 8.0. In the case where the exposure value is 14, the shutter speed is set to 1/125 and the aperture value (f-number) is set to 11.0.

By using the two methods as described above, the AF control can be performed. Concretely, the AF control can be performed by using both of the two methods or by using only the first method. Further, it is also possible to use the second method and, after that, determine a focus position so that one of images, which is preliminarily designated (for example, the image GF) preferentially always comes into in-focus.

### D. Fourth Embodiment

A fourth embodiment exemplifies a case where the range of a partial image is not set by the operator but is automatically set by a digital camera. The fourth embodiment is a modification of the first embodiment and the point different from the first embodiment will be mainly described below.

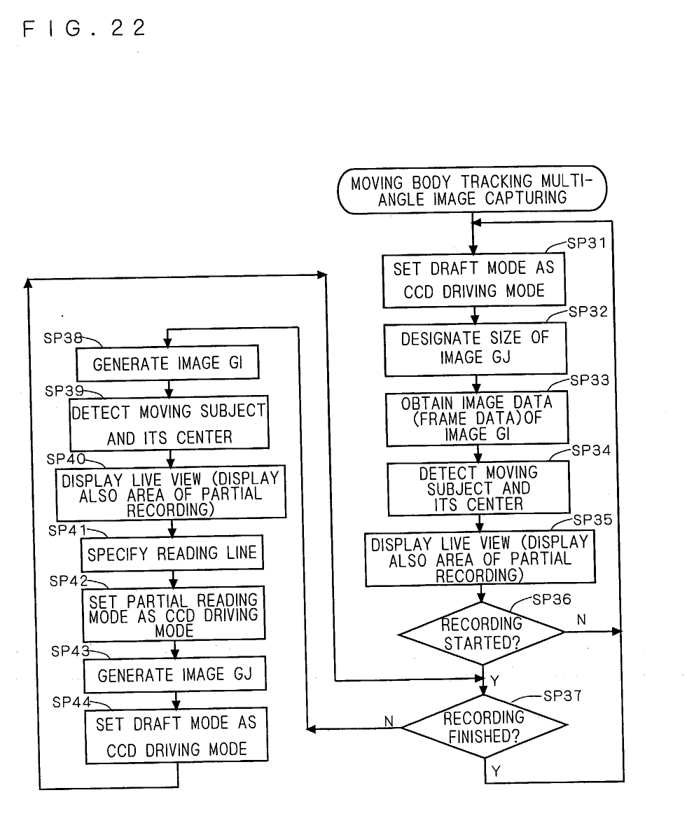

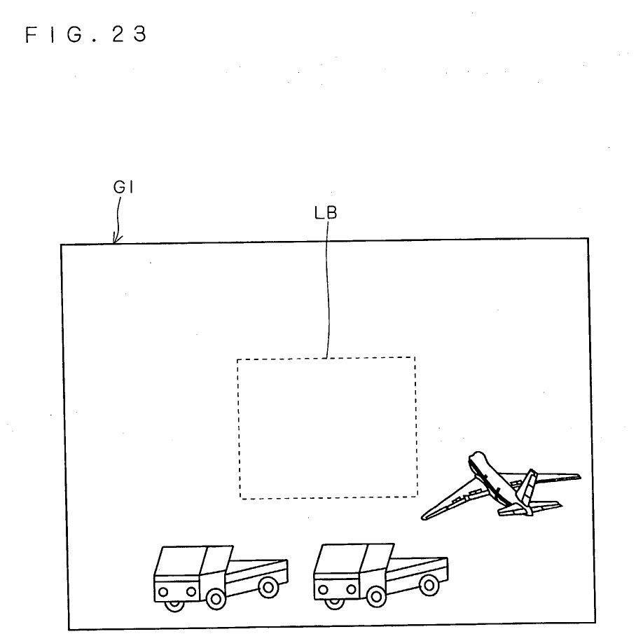

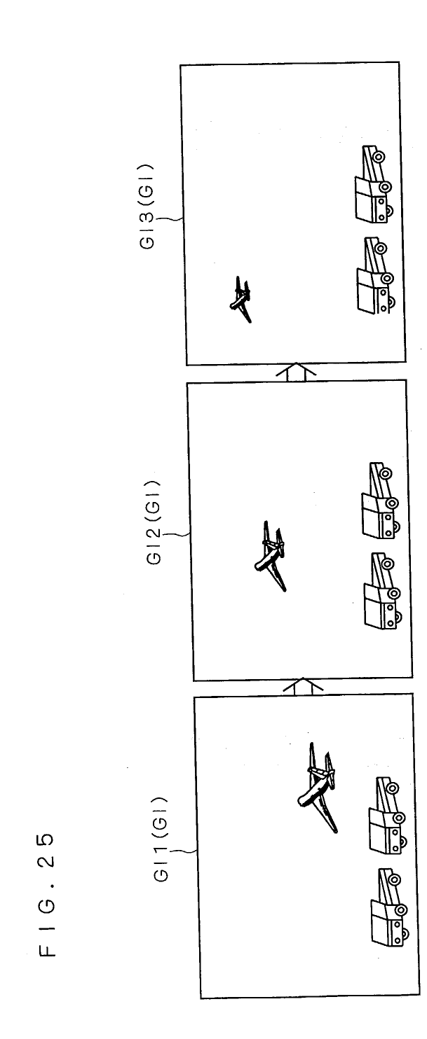

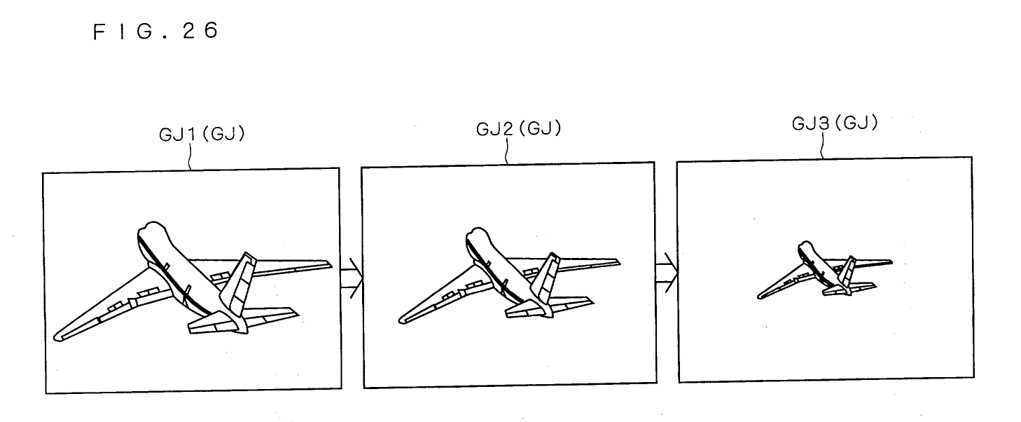

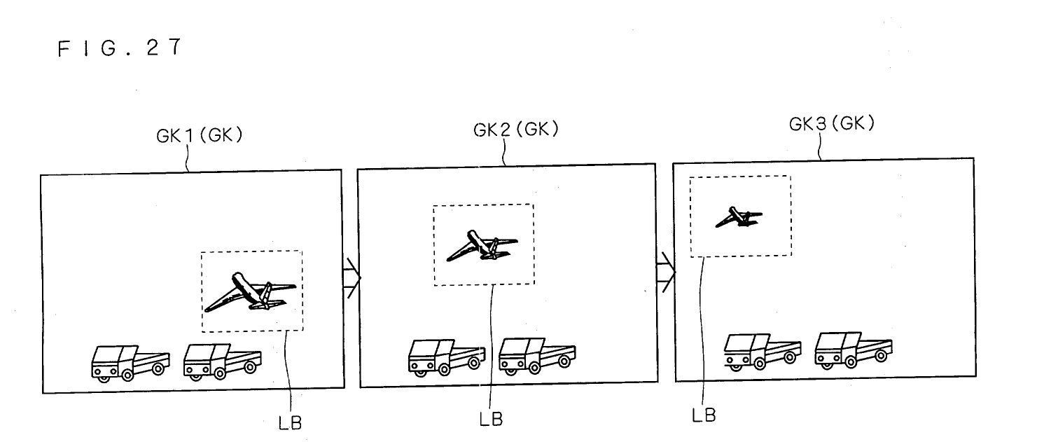

FIG. 22 is a flowchart showing a plural moving images recording operation according to the fourth embodiment. FIG. 23 shows an example of an objective image to be captured. By referring to FIGS. 22 and 23 and the like, description will be given of a case of automatically detecting an airplane as a moving body on the basis of a whole image GI and recording a partial image GJ (FIG. 26) corresponding to an area including the detected moving body and the whole image GI (FIG. 25) corresponding to the whole image capturing range as different moving image files. Various operations including an operation of determining the position of the image GJ are performed by the overall control unit 30.

In steps SP31 to SP36, a preparing operation for moving image capturing is performed. In steps SP37 to SP44, a moving image capturing operation is performed. Steps SP31, SP33, SP35 and SP36 are operations similar to those of steps SP1, SP3, SP4 and SP5 in FIG. 6, respectively. Steps SP37, SP38, SP40, SP42, SP43 and SP44 are operations similar to those of steps SP6, SP7, SP11, SP8, SP9 and SP10, respectively.

Concretely, in step SP31, the draft mode is set as the reading mode of the CCD image capturing device 20. In step SP32, the size of the image capturing range of the partial image GJ is set.

The size of the image GJ is set to a predetermined reference size in an initial state. After that, the operator changes the size of the range indicated by the broken line LB (FIG. 23) superimposed on a live view image on the LCD 5 by using the control button 7, thereby designating the size of the partial image GJ in the whole image capturing range. The digital camera 1 determines the image capturing range of the image GJ on the basis of the designation by the operator.

After that, the image GI corresponding to the whole image capturing range of the CCD image capturing device 20 is read in the draft mode from the CCD image capturing device 20 (step SP33).

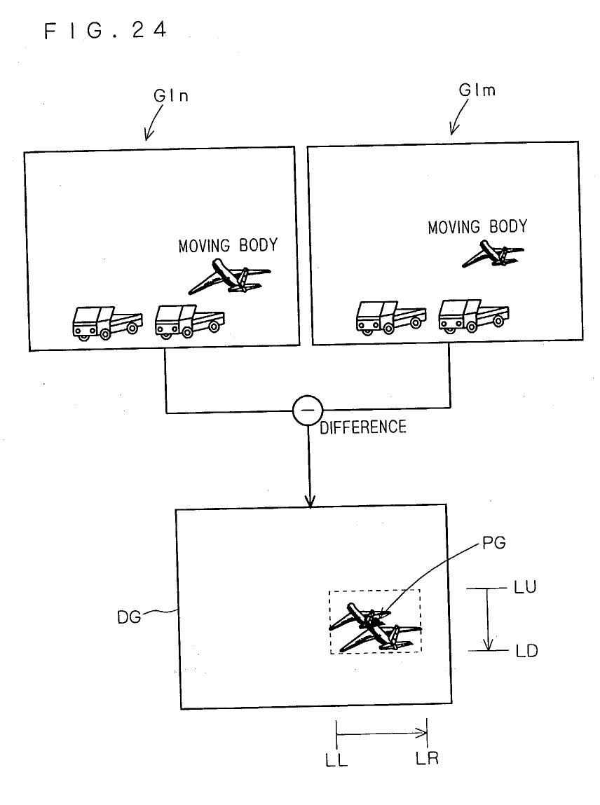

In step SP34, the center position of the moving subject is calculated. As shown in FIG. 24, the center position is detected by using an image GIn of the n-th frame and an image GIm of the m-th frame (where m>n). More specifically, a differential image DG between the image GIn of the n-th frame and the image GIm of the m-th frame is obtained, and a center of gravity position PG of the differential image DG is calculated as a center position of the moving subject. The differential image DG conceptually shows a state where the differential value of the images GIn and GIm is not detected with respect to a part corresponding to a stopped truck but the differential value of only the part corresponding to the airplane which is being moved is detected.

In step SP35, a live view image is displayed on the LCD 5. In the live view image, the range of the partial image GJ is shown by the broken line LB (see FIG. 27). In the case where the difference between the images GIn and GIm is not detected (that is, an area where a change with time does not exist), as show in FIG. 23, it is sufficient to set the area of the designated size in the center of the whole image GI as the image capturing range of the image GJ.

After that, in step SP36, when it is determined that the shutter button 9 enters the depressed state S2 and the recording start instruction is inputted, it is regarded that the recording start instruction is inputted, and the program advances to the following step SP37 and subsequent steps. In the other cases, the image capturing preparing operation is continuously performed.

In steps SP37 to SP44, the moving image capturing operation is performed.

In step SP38, the image GI is captured. In the following step SP39, an operation similar to that of step SP34 is performed to detect the center position of the moving body. The center position PG of the moving body is set as the center position of the image GJ.

In step SP40, the live view image is displayed on the LCD 5. In the live view display, the boundary of the area designated as the image capturing range of the image GJ in the image GI is continuously clearly indicated by using the broken line LB (see FIG. 27).

After that, the read pixel position corresponding to the image GJ is specified (step SP41), the reading mode of the CCD image capturing device 20 is changed to the partial reading mode (step SP42), and the image in the specified area is read (step SP43). Concretely, as shown in FIG. 24, a plurality of horizontal lines corresponding to a specified pixel position (specifically, from a read start line LU to a read end line LD) are read and blocks as a part of the read horizontal lines (pixel blocks from a line LL on the left end to a line LR on the right end) are extracted, thereby generating the image GJ having a size designated in step SP32.

After that, in step SP44, the draft mode is set again as the reading mode of the CCD image capturing device 20.

Subsequently, the moving image capturing process is repeatedly executed until it is determined in step SP37 that the recording end instruction is inputted.

As a result, a moving image file constructed by a series of images GI (a plurality of images GI including three representative images GI1, GI2 and GI3) showing the whole (global) image as shown in FIG. 25 and a moving image file constructed by a series of images GJ (a plurality of images GJ including three representative images GJ1, GJ2 and GJ3) each showing a part of the whole image as shown in FIG. 26 are generated. As shown in FIG. 27, on the LCD 5, an image GK in a state where the broken line LB is added to the image GI (herein, the plurality of images GK including three representative images GK1, GK2 and GK3) is shown as a live view image. As described above, a rectangular area surrounded by the broken line LB indicates the image capturing area of the image GJ.

As described above, the area of the partial image GJ is automatically determined, the whole image GI and the partial image GJ are read out while alternately switching the reading mode in the CCD image capturing device 20 between the draft mode and the partial reading mode, and the images GI and GJ can be recorded alternately.

### E. Fifth Embodiment

In a fifth embodiment, description will be given of a case of recording a plurality of moving images of different fields of view without switching the driving mode (reading mode) of the CCD image capturing device 20. The fifth embodiment is a modification of the first embodiment and the point different from the first embodiment will be mainly described below.

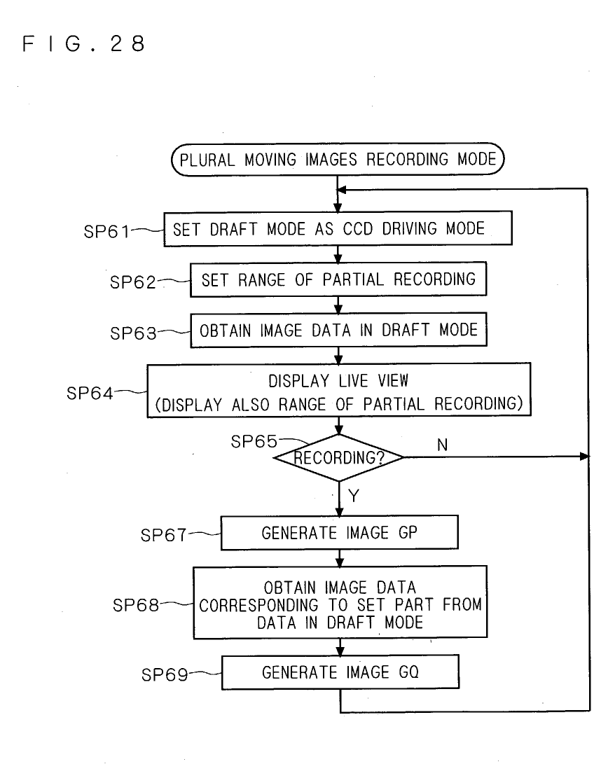

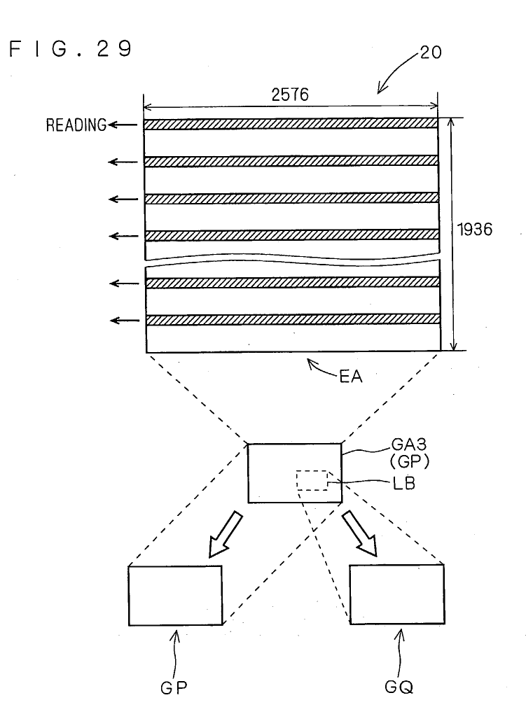

FIG. 28 is a flowchart showing a plural moving images recording operation according to the fifth embodiment. Herein, description will be given of a case of recording two moving images GP and GQ (see FIG. 29) on the basis of an image read from the CCD image capturing device 20 by using the draft mode.

In steps SP61 to SP65, a preparing operation for capturing a moving image is performed. In steps SP67 to SP69, the moving image recording operation is performed. Operations in steps SP61, SP62, SP63, SP64, SP67 and SP69 are similar to the operations in steps SP1, SP2, SP3, SP4, SP7 and SP9 (FIG. 6) in the first embodiment, respectively. The operation of step SP68 (that is, the operation of obtaining the partial image GQ) is different from the first embodiment.

Concretely, in step SP61, the draft mode is set as the reading mode of the CCD image capturing device 20. After that, in step SP62, the position of the image capturing range of the partial image GQ and the like are set. A method of setting the image capturing range of the partial image GQ is similar to that in the first embodiment.

After that, the image GP corresponding to the whole image capturing range of the CCD image capturing device 20 is read in the draft mode from the CCD image capturing device 20 (step SP63). The image GP is an image obtained in the same process as the process of generating the image GA3 (see FIG. 7).

In step SP64, a live view image is displayed on the LCD 5. The live view image is displayed, in a manner similar to the first embodiment, so that a broken line indicative of the image capturing area of the partial image GQ is added to the whole image GP.

After that, in step SP65, whether the recording operation is performed or not is determined. When the shutter start button 9 is kept on being depressed in the depressed state S2, it is determined that the recording instruction is continuously inputted. In other words, a moment the shutter start button 9 enters the depressed state S2 is a moment that the recording start instruction is inputted. A moment the depressed state S2 of the shutter button 9 is canceled is a moment the recording end instruction is inputted. When the recording instruction is inputted, the program advances to the next step SP67 and subsequent steps. In the other cases, the program returns to step SP61 and the image capturing preparing operation is continuously performed. The present invention is not limited to the above but the recording start and the recording end may be instructed by an operation similar to that of the first embodiment.

In steps SP67, SP68 and SP69, the moving image capturing operation is performed.

In step SP67, the whole image GP is recorded as a moving image. As shown in FIG. 29, the whole image GP is the same image as the image GA3 read in step SP63.

In step SP68, as shown in FIG. 29, an area as a part of the image GA3 (GP) read in step SP63 is extracted as the partial image GQ. The area to be extracted is an area surrounded by the broken line LB.

The resolution (or pixel size) of the partial image GQ is lower than that of the image GP. However, by setting the pixel size of the whole image GP to a large value and/or by properly setting the size of the partial image GQ relative to the whole image GP, the resolution can be set to be sufficiently high in practical use. Since the image GQ is an image extracted from the image GP, the images GQ and GP are images captured strictly at the same time (at the same moment).

After that, by performing a predetermined enlarging process, the size of the partial image GQ is adjusted to the size of the general image GP. When it is unneccesary to adjust the image size, the size of the extracted image may not be changed.

In step SP69, the image GQ is recorded as a moving image. Herein, the images GP and GQ are recorded as different moving image files.

After that, until it is determined in step SP65 that the recording end instruction is inputted, the moving image capturing process is repeatedly executed.

By the operation as described above, image data corresponding to the whole area of the CCD image capturing device 20 is read at once in the draft mode, the image GP itself of the whole area and the image GQ as a partial area of the whole area are extracted as the images GP and GQ corresponding to the whole area and the partial area, respectively, and alternately recorded, thereby enabling two pieces of moving image data to be generated. Since it is unnecessary to prepare a plurality of cameras, a plurality of images of different fields of view can be easily captured.

### F. Others

Although the embodiments of the present invention have been described above, the present invention is not limited thereto.

For example, in the fourth embodiment, the case of determining the area in which a change with time occurs in the image GI corresponding to the whole area as the area of the partial image GJ has been described. The present invention however is not limited thereto. For example, an area having luminance of a predetermined value or higher (that is a bright area) may be determined as the area of the partial image GJ or an area of a specific color may be determined as the area of the partial image GJ. Whether the area is an area of a specific color or not may be determined by detecting the hue of the area or the like.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
a single image capturing unit having an image capturing optical system and at least one image sensor for generating image data constructed by a plurality of pixels by using photoelectric conversion on a subject image from the image capturing optical system;
a first reader for reading image data of a first area in said at least one image sensor;
a second reader for reading image data of a second area in said at least one image sensor;
a reading controller for alternately performing reading of image data by said first reader and reading of image data by said second reader;
a first recorder for recording the image data read by said first reader; and
a second recorder for recording the image data read by said second reader.

2. The image capturing apparatus according to claim 1, wherein
said reading controller switches a driving mode of said image sensor at the time of alternately reading the image data.

3. The image capturing apparatus according to claim 1, wherein
said reading controller switches designation of pixels to be read at the time of alternately reading the image data.

4. The image capturing apparatus according to claim 3, wherein
said at least one image sensor is a CMOS sensor.

5. The image capturing apparatus according to claim 1, further comprising:
a display for displaying the image data read by said first and second readers.

6. The image capturing apparatus according to claim 5, wherein
said display displays said second area.

7. The image capturing apparatus according to claim 5, wherein
said display displays image data of an area including said first and second areas.

8. The image capturing apparatus according to claim 1, further comprising:
a recording controller for alternately performing recording of image data by said first recorder and recording of image data by said second recorder.

9. The image capturing apparatus according to claim 1, further comprising:
an exposure control circuit for calculating an exposure control value for recording the image data of said second area on the basis of image data read by said first reader.

10. The image capturing apparatus according to claim 1, further comprising:
a white balance adjusting circuit for adjusting a white balance of the image data of said second area on the basis of image data read by said first reader.

11. The image capturing apparatus according to claim 1, further comprising:
a focus adjusting circuit for performing focus adjustment at the time of recording image data of said first area on the basis of image data read by said second reader.

12. The image capturing apparatus according to claim 1, further comprising:
an aperture control circuit for controlling an aperture so that in-focus is achieved on both said first and second areas.

13. The image capturing apparatus according to claim 1, further comprising:
a selector for selecting said second area on the basis of image data read by said first reader.

14. The image capturing apparatus according to claim 13, wherein
said selector selects an area having a change with time as said second area.

15. The image capturing apparatus according to claim 1, wherein
said second area is a center portion of said first area.

16. An image capturing apparatus comprising:
a single image capturing unit having an image capturing optical system and at least one image sensor for generating image data constructed by a plurality of pixels by using photoelectric conversion on a subject image from the image capturing optical system;
a reader for reading image data of first and second areas in said at least one image sensor;
a first recorder for recording the image data of the first area read by said reader;
a second recorder for recording the image data of the second area read by said reader; and
a recording controller for alternately performing the recording of image data by said first recorder and the recording of image data by said second recorder to generate moving image data.

17. An image capturing apparatus comprising:
at least one image sensor for generating image data;
a first reader for reading image data of a first area in said at least one image sensor;
a second reader for reading image data of a second area in said at least one image sensor;
a first file generator for generating a first moving image file from the image data read by said first reader;
a second file generator for generating a second moving image file from the image data read by said second reader; and
a file recorder for recording said first and second moving image files generated by said first and second file generators into a recording medium.

18. The image capturing apparatus according to claim 17, wherein
said file recorder records said first and second moving image files so as to be associated with each other.

19. The image capturing apparatus according to claim 18, wherein
said file recorder assigns a file name to each of said first and second moving image files, said file name having an identification part for identifying a capturing area in said at least one image sensor and a number part for indicating a file number.

20. The image capturing apparatus according to claim 19, wherein
said file recorder uniquely assigns, as said file number, a serial number irrespective of the capturing area to each of the said first and second moving image files.

21. The image capturing apparatus according to claim 17, further comprising:
a sound recorder for recording sound data to said first and second moving image files.
